(19) United States
(12) Patent Application Publication
(10) Pub. No.: US 2026/0160303 A1
(43) Pub. Date: Jun. 11, 2026

(54) POWER TRANSMISSION DEVICE

(71) Applicant: EXEDY Corporation, Osaka (JP)

(72) Inventor: Hiroshi UEHARA, Osaka (JP)

(21) Appl. No.: 19/386,421

(22) Filed: Nov. 12, 2025

(30) Foreign Application Priority Data
Dec. 9, 2024 (JP) 2024-214437

(51) Int. Cl. F16D 7/02

(52) U.S. Cl. CPC F16D 7/027

(57) ABSTRACT

A power transmission device includes a torque limiter and a damper unit. The torque limiter includes a first side plate, a second side plate, and a friction plate. The damper unit includes a first rotary member, a second rotary member, and an elastic member. The first rotary member is configured to be rotated unitarily with the friction plate. The second side plate includes an annular portion and a cylindrical portion. The annular portion extends in a circumferential direction. The cylindrical portion extends from an outer peripheral end of the annular portion to a first side in an axial direction. The first rotary member includes an outer peripheral surface in contact with an inner peripheral surface of the cylindrical portion.

### CROSS-REFERENCE TO RELATED APPLICATIONS

This application is based on and claims the priority benefit of Japanese application No. 2024-214437 filed on Dec. 9, 2024, the contents of which are incorporated herein by reference.

### TECHNICAL FIELD

The present invention relates to a power transmission device.

### BACKGROUND

A power transmission device disclosed in Japan Laid-open Patent Application Publication No. 2021-196012 includes a torque limiter and a damper unit. The damper unit includes a first rotary member, a second rotary member, and elastic members. The first rotary member is rotatable relative to the second rotary member. The elastic members elastically couple the first and second rotary members therethrough to each other.

### SUMMARY OF THE INVENTION

In such an attempt to increase the inertia of the first rotary member, it is important to inhibit the imbalance of the first rotary member. In view of this, it is an object of the present invention to inhibit the imbalance of the first rotary member.

A power transmission device according to a first aspect includes a torque limiter and a damper unit. The torque limiter includes a first side plate, a second side plate, and a friction plate. The second side plate is disposed on a first side of the first side plate in an axial direction. The second side plate is smaller in plate thickness than the first side plate. The friction plate is disposed axially between the first and second side plates. The friction plate is disposed to be rotatable relative to the first and second side plates. The damper unit includes a first rotary member, a second rotary member, and an elastic member. The first rotary member is configured to be rotated unitarily with the friction plate. The second rotary member is disposed to be rotatable relative to the first rotary member. The elastic member elastically couples the first and second rotary members therethrough to each other. The second side plate includes an annular portion and a cylindrical portion. The annular portion extends in a circumferential direction. The cylindrical portion extends from an outer peripheral end of the annular portion to the first side in the axial direction. The first rotary member includes an outer peripheral surface in contact with an inner peripheral surface of the cylindrical portion.

According to the configuration, the outer peripheral surface of the first rotary member is supported by the cylindrical portion of the second side plate; hence, it is made possible to inhibit the imbalance of the first rotary member.

A power transmission device according to a second aspect relates to the power transmission device according to the first aspect and is configured as follows. The outer peripheral surface of the first rotary member includes a contact portion and a non-contact portion. The contact portion extends in a circular-arc shape as seen in the axial direction. The contact portion is in contact with the inner peripheral surface of the cylindrical portion. The non-contact portion extends straight as seen in the axial direction. The non-contact portion is not in contact with the inner peripheral surface of the cylindrical portion.

A power transmission device according to a third aspect relates to the power transmission device according to the first or second aspect and is configured as follows. An outer peripheral edge of the first rotary member is disposed radially outside an outer peripheral edge of the friction plate.

A power transmission device according to a fourth aspect relates to the power transmission device according to any of the first to third aspects and is configured as follows. The torque limiter includes a fastening member fastening the first and second side plates therethrough to each other. The cylindrical portion is disposed radially outside the fastening member.

A power transmission device according to a fifth aspect relates to the power transmission device according to any of the first to fourth aspects and is configured as follows. The torque limiter includes an inertia member. The inertia member is configured to be rotated unitarily with the first side plate.

A power transmission device according to a sixth aspect relates to the power transmission device according to the fifth aspect and is configured as follows. The torque limiter includes a fastening member fastening the first side plate and the inertia member therethrough to each other. The cylindrical portion is disposed radially outside the fastening member.

A power transmission device according to a seventh aspect relates to the power transmission device according to the fifth or sixth aspect and is configured as follows. The inertia member includes a screw hole extending in the axial direction.

A power transmission device according to an eighth aspect relates to the power transmission device according to any of the fifth to seventh aspects and is configured as follows. The inertia member is made in shape of an annulus extending in the circumferential direction. The inertia member is larger in plate thickness than the first side plate.

A power transmission device according to a ninth aspect relates to the power transmission device according to any of the fifth to seventh aspects and is configured as follows. The inertia member is a nut with a thickness larger than the plate thickness of the first side plate.

A power transmission device according to a tenth aspect relates to the power transmission device according to any of the fifth to ninth aspects and further includes a drive plate. The drive plate is disposed on a second side of the first side plate in the axial direction. The first side plate is configured to be rotated unitarily with the drive plate. The inertia member is disposed between the drive plate and the first side plate in the axial direction.

A power transmission device according to an eleventh aspect relates to the power transmission device according to any of the first to tenth aspects and is configured as follows. The first side plate includes an annular portion and a cylindrical portion. The annular portion of the first side plate extends in the circumferential direction. The cylindrical portion of the first side plate extends from an outer peripheral end of the annular portion of the first side plate to a second side in the axial direction.

Overall, according to the present invention, it is made possible to inhibit the imbalance of the first rotary member.

### BRIEF DESCRIPTION OF THE DRAWINGS

FIG. 1 is a front view of a power transmission device.

FIG. 2 is a cross-sectional view of the power transmission device taken along line II-II in FIG. 1.

FIG. 3 is an enlarged cross-sectional view of the power transmission device.

FIG. 4 is a cross-sectional view of a power transmission device according to a modification.

### DETAILED DESCRIPTION

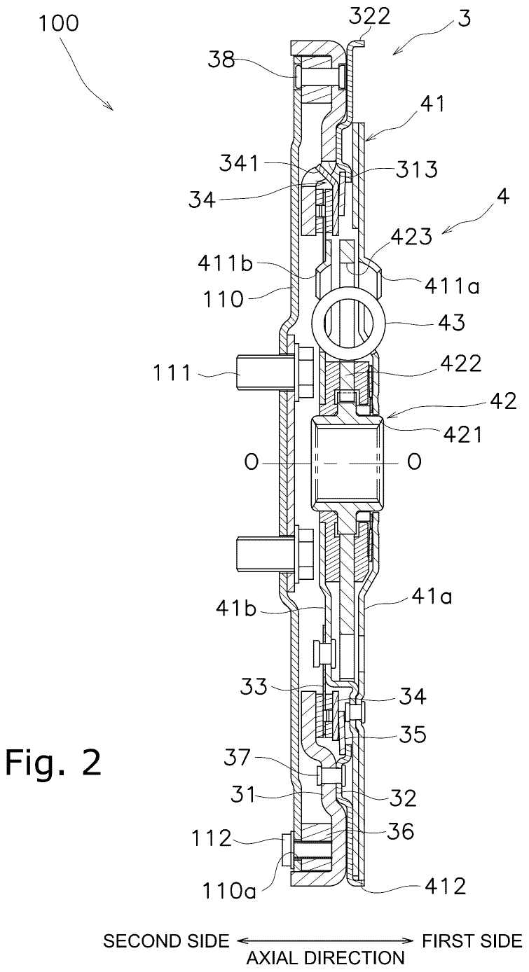

A power transmission device 100 according to the present preferred embodiment will be hereinafter explained with reference to drawings. It should be noted that in the following explanation, the term “axial direction” refers to an extending direction of a rotational axis O for the power transmission device 100. On the other hand, the term “circumferential direction” refers to a circumferential direction of an imaginary circle about the rotational axis O, whereas the term “radial direction” refers to a radial direction of the imaginary circle about the rotational axis O. In addition, the term “first side in the axial direction” means the right side in FIG. 2, whereas the term “second side in the axial direction” means the left side in FIG. 2.

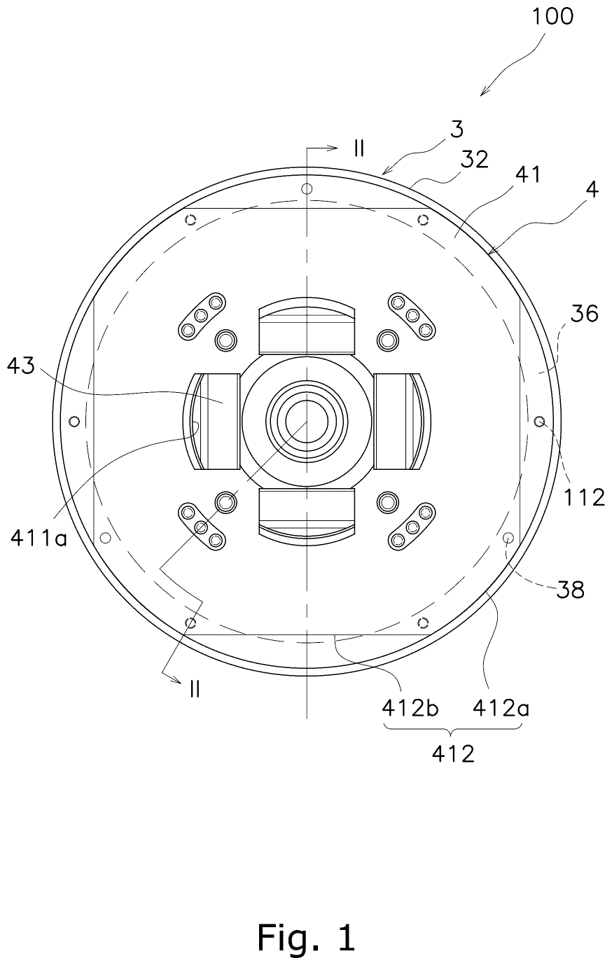

FIG. 1 is a front view of the power transmission device 100, whereas FIG. 2 is a cross-sectional view of the power transmission device 100 taken along line II-II in FIG. 1. As shown in FIGS. 1 and 2, the power transmission device 100 includes a drive plate 110, a torque limiter 3, and a damper unit 4. The drive plate 110 and the torque limiter 3 are configured to be rotated unitarily with each other. The torque limiter 3 and the damper unit 4, albeit rotatable relative to each other, are basically rotated unitarily with each other. When a torque inputted to the power transmission device 100 exceeds a predetermined value, the torque limiter 3 and the damper unit 4 are rotated relative to each other.

The power transmission device 100 is installed between a prime mover (omitted in illustration) and an output-side member (omitted in illustration). It should be noted that the prime mover refers to, for instance, an internal combustion engine. On the other hand, the output-side member refers to, for instance, an electric motor, a transmission, or so forth. The internal combustion engine is disposed on the second side (the left side in FIG. 2) of the power transmission device 100 in the axial direction, whereas the output-side member is disposed on the first side (the right side in FIG. 2) of the power transmission device 100 in the axial direction. The power transmission device 100 is configured to limit a torque transmitted between the internal combustion engine and the output-side member and attenuate fluctuations in torque.

### [Drive Plate]

The drive plate 110 is configured to receive a torque outputted from the prime mover. Specifically, the drive plate 110 is attached to, for instance, a crankshaft (omitted in illustration) by a plurality of bolts 111. The drive plate 110 includes a plurality of through holes 110a. The through holes 110a are disposed at intervals in the circumferential direction. The drive plate 110 has a disc shape.

### [Damper Unit]

The damper unit 4 is attached to the torque limiter 3. The damper unit 4 is configured to attenuate fluctuations in rotation. The damper unit 4 includes a first rotary member 41, a second rotary member 42, and a plurality of elastic members 43.

### <First Rotary Member>

The first rotary member 41 is rotated unitarily with a friction plate 33 of the torque limiter 3 (to be described). The first rotary member 41 includes a first plate 41a and a second plate 41b. Each of the first and second plates 41a and 41b is an annular member including a center hole. The first and second plates 41a and 41b are rotated unitarily with each other. Also, the first and second plates 41a and 41b are axially immovable relative to each other.

The first and second plates 41a and 41b are disposed away from each other at an interval in the axial direction. The second plate 41b is disposed on the second side of the first plate 41a in the axial direction.

The first plate 41a includes a plurality of window portions 411a, while the second plate 41b includes a plurality of window portions 411b. It should be noted that in the present preferred embodiment, the first plate 41a includes four window portions 411a, while the second plate 41b includes four window portions 411b; however, the window portions 411a, 411b are not limited in number to this.

Not only the window portions 411a but also the window portions 411b are disposed away from each other at intervals in the circumferential direction. Not only the window portions 411a but also the window portions 411b are configured to accommodate the elastic members 43, respectively.

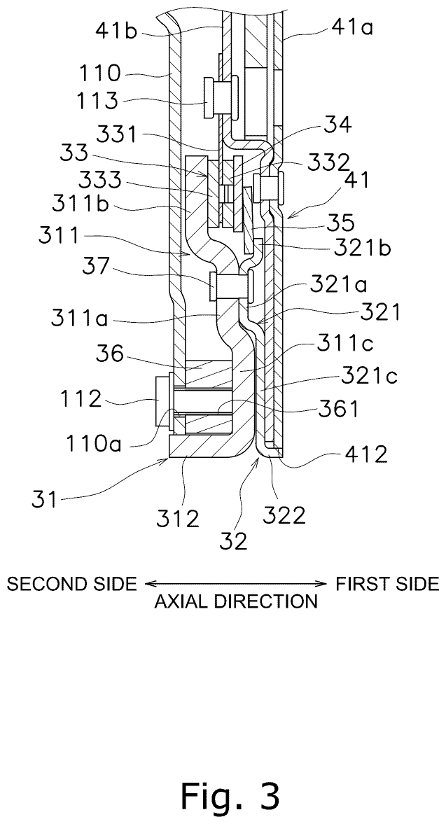

FIG. 3 is an enlarged cross-sectional view of the power transmission device 100. As shown in FIG. 3, the first rotary member 41 is in contact at an outer peripheral surface 412 thereof with the inner peripheral surface of a second cylindrical portion 322 of a second side plate 32 (to be described). It should be noted that the outer peripheral surface 412 of the first rotary member 41 is composed of at least one of the outer peripheral surfaces of the first and second plates 41a and 41b.

As shown in FIG. 1, the outer peripheral surface 412 of the first rotary member 41 includes a plurality of contact portions 412a and a plurality of non-contact portions 412b. It should be noted that in the present preferred embodiment, the outer peripheral surface 412 of the first rotary member 41 includes four contact portions 412a and four non-contact portions 412b.

Each contact portion 412a extends in a circular-arc shape as seen in the axial direction. Each contact portion 412a is in contact with the inner peripheral surface of the second cylindrical portion 322. Each non-contact portion 412b extends straight as seen in the axial direction. Each non-contact portion 412b is not in contact with the inner peripheral surface of the second cylindrical portion 322.

As shown in FIGS. 2 and 3, the outer peripheral edge of the first rotary member 41 is disposed radially outside that of the friction plate 33. The first rotary member 41 overlaps at an outer peripheral part thereof with a plurality of first fastening members 37 (to be described) as seen in the axial direction. In addition, the first rotary member 41 overlaps at the outer peripheral part thereof with an inertia member 36 (to be described) as seen in the axial direction. The outer peripheral part of the first rotary member 41 is disposed on the first side of the torque limiter 3 in the axial direction.

### <Second Rotary Member>

The second rotary member 42 is configured to transmit the torque, inputted thereto from the first rotary member 41, to the output-side member. The second rotary member 42 is disposed axially between the first and second plates 41a and 41b. The second rotary member 42 is disposed to be rotatable relative to the first and second plates 41a and 41b.

The second rotary member 42 includes a hub 421 and a flange plate 422. The hub 421 and the flange plate 422 are separated as different members but may be integrated as a single member.

The hub 421 has a tubular shape and extends in the axial direction. The hub 421 is disposed in the center hole of the first plate 41a and that of the second plate 41b. The hub 421 is provided with a spline hole, extending in the axial direction, in an inner peripheral part thereof. The spline hole enables an input shaft of the output-side member to be spline-coupled thereto.

The flange plate 422 radially extends from the outer peripheral surface of the hub 421. The flange plate 422 has an annular shape. The flange plate 422 is disposed to be rotatable relative to the first and second plates 41a and 41b. The flange plate 422 is disposed axially between the first and second plates 41a and 41b.

The flange plate 422 includes a plurality of accommodation holes 423. It should be noted that in the present preferred embodiment, the flange plate 422 includes four accommodation holes 423; however, the accommodation holes 423 are not limited in number to this. The accommodation holes 423 are disposed away from each other at intervals in the circumferential direction. The accommodation holes 423 are configured to accommodate the elastic members 43, respectively. The accommodation holes 423 are disposed to overlap with not only the window portions 411a but also the window portions 411b, respectively, as seen in the axial direction.

### <Elastic Members>

The elastic members 43 are configured to elastically couple the first and second rotary members 41 and 42 therethrough to each other in a rotational direction. The elastic members 43 are, for instance, coil springs.

The elastic members 43 are accommodated in the accommodation holes 423 of the second rotary member 42, respectively. In addition, the elastic members 43 are accommodated in not only the window portions 411a of the first plate 41a but also the window portions 411b of the second plate 41b, respectively.

### [Torque Limiter]

The torque limiter 3 is disposed to be rotatable about the rotational axis O. The torque limiter 3 is disposed on the first side of the drive plate 110 in the axial direction. The torque limiter 3 has an annular shape. The torque limiter 3 is configured to be attached to the drive plate 110.

The torque limiter 3 is configured to limit the torque transmitted between the drive plate 110 and the damper unit 4. In other words, the torque limiter 3 is configured to restrict transmission of the torque in the power transmission device 100 when the torque is greater than or equal to the predetermined value.

The torque limiter 3 includes a first side plate 31, the second side plate 32, the friction plate 33, a pressure plate 34, an urging member 35, the inertia member 36, the first fastening members 37, and a plurality of second fastening members 38.

### <First Side Plate>

The first side plate 31 is disposed on the first side of the drive plate 110 in the axial direction. In other words, the drive plate 110 is disposed on the second side of the first side plate 31 in the axial direction. The first side plate 31 is attached to the drive plate 110. Specifically, the first side plate 31 is attached to the drive plate 110 through the inertia member 36.

The first side plate 31 is rotated unitarily with the drive plate 110. The first side plate 31 has an annular shape. The first side plate 31 is larger in plate thickness than the drive plate 110.

The first side plate 31 includes a first annular portion 311 and a first cylindrical portion 312. The first annular portion 311 and the first cylindrical portion 312 are integrated as a single member.

The first annular portion 311 is made in the shape of an annulus extending in the circumferential direction. The first annular portion 311 includes an intermediate portion 311a, a first inner peripheral portion 311b, and a first outer peripheral portion 311c. The intermediate portion 311a is disposed radially between the first inner peripheral portion 311b and the first outer peripheral portion 311c. The intermediate portion 311a is disposed on the second side of the first outer peripheral portion 311c in the axial direction.

The first inner peripheral portion 311b is disposed radially inside the intermediate portion 311a. The first inner peripheral portion 311b is in contact with the friction plate 33. The first inner peripheral portion 311b is disposed on the second side of the intermediate portion 311a in the axial direction.

The first outer peripheral portion 311c is disposed radially outside the intermediate portion 311a. The first outer peripheral portion 311c is in contact with the inertia member 36.

The first cylindrical portion 312 extends from the outer peripheral end of the first annular portion 311 in the axial direction. When described in detail, the first cylindrical portion 312 extends from the outer peripheral end of the first annular portion 311 to the second side in the axial direction. In other words, the first cylindrical portion 312 extends from the outer peripheral end of the first annular portion 311 toward the drive plate 110 in the axial direction. It should be noted that the first cylindrical portion 312 can be formed by bending an outer peripheral part of the first side plate 31 in the axial direction. The first side plate 31 can be formed by sheet metal processing or stamping.

The first cylindrical portion 312 overlaps with the drive plate 110 as seen in the radial direction. When described in detail, the first cylindrical portion 312 overlaps at the distal end thereof (the end thereof disposed on the second side in the axial direction) with the drive plate 110 as seen in the radial direction. The drive plate 110 is in contact at the outer peripheral surface thereof with the inner peripheral surface of the first cylindrical portion 312.

### <Second Side Plate>

The second side plate 32 is disposed on the first side of the first side plate 31 in the axial direction. The friction plate 33, the pressure plate 34, and the urging member 35 are disposed axially between the first and second side plates 31 and 32. The second side plate 32 is smaller in plate thickness than the first side plate 31.

The second side plate 32 is configured to be rotated unitarily with the first side plate 31. The second side plate 32 is fastened to the first side plate 31 by the plural first fastening members 73. The first fastening members 73 are disposed at intervals in the circumferential direction. The first fastening members 73 are, for instance, rivets.

The second side plate 32 includes a second annular portion 321 and the second cylindrical portion 322. The second annular portion 321 and the second cylindrical portion 322 are integrated as a single member.

The second annular portion 321 is made in the shape of an annulus extending in the circumferential direction. The second annular portion 321 is approximately equal in outer diameter to the first annular portion 311. The second annular portion 321 overlaps with the second fastening members 38 as seen in the axial direction. The second annular portion 321 is larger in inner diameter than the first annular portion 311. The second annular portion 321 includes a bulging portion 321a, a second inner peripheral portion 321b, and a second outer peripheral portion 321c.

The bulging portion 321a is disposed radially between the second inner peripheral portion 321b and the second outer peripheral portion 321c. The bulging portion 321a bulges in the axial direction. The bulging portion 321a bulges toward the first side plate 31. In other words, the bulging portion 321a bulges to the second side in the axial direction. The bulging portion 321a is disposed on the second side of the second inner peripheral portion 321b and the second outer peripheral portion 321c in the axial direction.

The bulging portion 321a extends in the circumferential direction. The bulging portion 321a is in contact with the intermediate portion 311a in the axial direction. The first fastening members 37 fasten the intermediate portion 311a and the bulging portion 321a therethrough to each other.

The second inner peripheral portion 321b is disposed radially inside the bulging portion 321a. The second inner peripheral portion 321b supports the urging member 35. The second inner peripheral portion 321b is disposed away from the first inner peripheral portion 311b at an interval in the axial direction. The friction plate 33, the pressure plate 34, and the urging member 35 are disposed axially between the first and second inner peripheral portions 311b and 321b.

The second outer peripheral portion 321c is disposed radially outside the bulging portion 321a. The second outer peripheral portion 321c is in contact with the first outer peripheral portion 311c in the axial direction. The second outer peripheral portion 321c overlaps with the first outer peripheral portion 311c and the inertia member 36 as seen in the axial direction.

The second cylindrical portion 322 extends from the outer peripheral end of the second annular portion 321 to the first side in the axial direction. In other words, the second cylindrical portion 322 extends from the outer peripheral end of the second annular portion 321 in the axial direction so as to separate from the first side plate 31. The second cylindrical portion 322 extends to a side opposite to extension of the first cylindrical portion 312 in the axial direction. It should be noted that the second cylindrical portion 322 can be formed by bending an outer peripheral part of the second side plate 32 in the axial direction. The second side plate 32 can be formed by sheet metal processing or stamping.

The second cylindrical portion 322 is disposed radially outside the first fastening members 37. In addition, the second cylindrical portion 322 is disposed radially outside the second fastening members 38. The second cylindrical portion 322 overlaps with the first rotary member 41 as seen in the radial direction. The first rotary member 41 is in contact at the outer peripheral surface 412 thereof with the inner peripheral surface of the second cylindrical portion 322.

### <Friction Plate>

The friction plate 33 is a plate made in the shape of an annulus extending in the circumferential direction. The friction plate 33 is disposed to be rotatable about the rotational axis O. The friction plate 33 is disposed to be rotatable relative to the first and second side plates 31 and 32.

The friction plate 33 is in contact with the first side plate 31 in the axial direction. When described in detail, the friction plate 33 is in contact with the first inner peripheral portion 311b of the first annular portion 311 in the axial direction. The friction plate 33 is configured to be engaged by friction with the first side plate 31.

The friction plate 33 is attached to the first rotary member 41. When described in detail, the friction plate 33 is attached to the second plate 41b. For example, the friction plate 33 is attached to the second plate 41b by one or more fastening members 113. The friction plate 33 is rotated unitarily with the first rotary member 41. It should be noted that the friction plate 33 is provided as a discrete member separated from the second plate 41b; alternatively, the friction plate 33 may be integrated with the second plate 41b as a single member.

The friction plate 33 includes a plate body 331, a first friction material 332, and a second friction material 333. The plate body 331 is made in the shape of an annulus extending in the circumferential direction. The first friction material 332 is attached to the axially first side one of the surfaces of the plate body 331. The second friction material 333 is attached to the axially second side one of the surfaces of the plate body 331. The first and second friction materials 332 and 333 are rotated unitarily with the plate body 331. Each of the first and second friction materials 332 and 333 has an annular shape. The first and second friction materials 332 and 333 are attached to an outer peripheral part of the plate body 331.

### <Pressure Plate>

The pressure plate 34 has an annular shape. The pressure plate 34 is disposed axially between the urging member 35 and the friction plate 33. The pressure plate 34 holds the friction plate 33 in cooperation with the first side plate 31, with the friction plate 33 interposed therebetween. The pressure plate 34 is in contact with the first friction material 332, while the first side plate 31 is in contact with the second friction material 333.

The pressure plate 34 is configured to be rotated unitarily with the first side plate 31. It should be noted that the pressure plate 34 is axially movable with respect to the first side plate 31. Specifically, the pressure plate 34 includes a plurality of protruding portions 341 protruding radially outward (see FIG. 2). The protruding portions 341 are engaged with a plurality of engaging holes 313 provided in the first side plate 31, respectively, whereby the pressure plate 34 is rotated unitarily with the first side plate 31, while being axially movable with respect thereto.

### <Urging Member>

The urging member 35 is disposed axially between the second side plate 32 and the pressure plate 34. The urging member 35 urges the pressure plate 34 to the second side in the axial direction. In other words, the urging member 35 urges the pressure plate 34 toward the first side plate 31. Accordingly, the friction plate 33 is held by the pressure plate 34 and the first side plate 31, while being interposed therebetween. The urging member 35 is made in the shape of an annulus extending in the circumferential direction. The urging member 35 is, for instance, a disc spring. The urging member 35 is in contact at the outer peripheral end thereof with the second inner peripheral portion 321b, while being in contact at the inner peripheral end thereof with the pressure plate 34.

### <Inertia Member>

The inertia member 36 is made in the shape of an annulus extending in the circumferential direction. The inertia member 36 is larger in plate thickness than the first side plate 31. It should be noted that the plate thickness of the inertia member 36 means the axial dimension thereof. The inertia member 36 is disposed on the second side of the first side plate 31 in the axial direction. The inertia member 36 is sandwiched by the first side plate 31 and the drive plate 110 in the axial direction. It should be noted that another member may be interposed between the inertia member 36 and the first side plate 31; alternatively (or furthermore), another member (or yet another member) may be interposed between the inertia member 36 and the drive plate 110.

The inertia member 36 is configured to be rotated unitarily with the first side plate 31. Specifically, the inertia member 36 is fastened to the first side plate 31 by the plural second fastening members 38. The second fastening members 38 are, for instance, rivets.

The inertia member 36 is configured to be fixed to the drive plate 110. When described in detail, the inertia member 36 includes a plurality of screw holes 361. Each screw hole 361 opens to the second side in the axial direction. It should be noted that in the present preferred embodiment, each screw hole 361 penetrates the inertia member 36 in the axial direction; hence, each screw hole 361 opens to the first side in the axial direction as well. A plurality of bolts 112 are screwed into the screw holes 361 of the inertia member 36, respectively, while penetrating the through holes 110a of the drive plate 110, respectively. In other words, the bolts 112 fasten the drive plate 110 and the inertia member 36 therethrough to each other. Accordingly, the torque limiter 3 is attached to the drive plate 110.

The inertia member 36 overlaps with the first cylindrical portion 312 as seen in the radial direction. When described in detail, the outer peripheral surface of the inertia member 36 is opposed to the inner peripheral surface of the first cylindrical portion 312. The inertia member 36 overlaps with the first annular portion 311 as seen in the axial direction. When described in detail, the inertia member 36 overlaps with the first outer peripheral portion 311c as seen in the axial direction. The inertia member 36 is opposed to the first annular portion 311. It should be noted that another member may be interposed between the inertia member 36 and the first annular portion 311.

The inertia member 36 is disposed radially outside the intermediate portion 311a. The inertia member 36 is disposed radially between the first cylindrical portion 312 and the intermediate portion 311a. Thus, the inertia member 36 is disposed in a space defined by the first cylindrical portion 312, the first outer peripheral portion 311c, the intermediate portion 311a, and the drive plate 110.

### [Modifications]

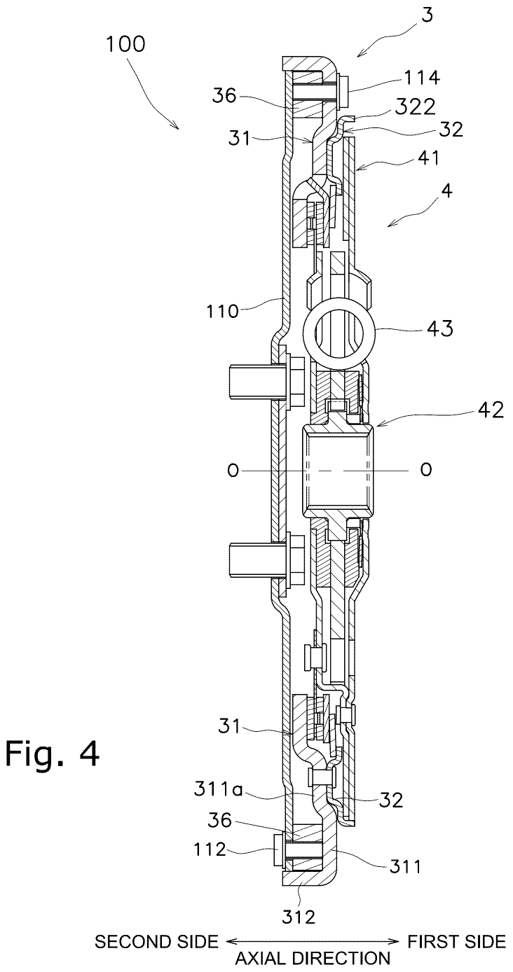

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.
(a) In the preferred embodiment described above, the inertia member 36 is made in the shape of the annulus extending in the circumferential direction; however, the inertia member 36 is not limited in configuration to this. For example, the inertia member 36 may be composed of a plurality of nuts 36. The nuts 36 are disposed at intervals in the circumferential direction. Each nut 36 has a thickness larger than the plate thickness of the first side plate 31. For example, each nut 36 may be fixed to the first side plate 31 by welding or so forth. Alternatively, the torque limiter 3 may not include the inertia member 36.
(b) In the preferred embodiment described above, the first cylindrical portion 312 extends from the first annular portion 311 to the second side in the axial direction; however, the first side plate 31 is not limited in configuration to this. For example, the first cylindrical portion 312 may extend from the outer peripheral end of the first annular portion 311 to the first side in the axial direction. In this case, the inertia member 36 can be disposed on the first side of the first annular portion 311 in the axial direction so as to overlap with the first cylindrical portion 312 as seen in the radial direction. Alternatively, the first side plate 31 may not include the first cylindrical portion 312.
(c) In the preferred embodiment described above, the second side plate 32 is approximately equal in outer diameter to the first side plate 31; however, the second side plate 32 is not limited in configuration to this. For example, as shown in FIG. 4, the second side plate 32 may be smaller in outer diameter than the first side plate 31. The second cylindrical portion 322 is disposed radially inside the inertia member 36. Specifically, the second cylindrical portion 322 is disposed radially inside one or more bolts 114 that fasten the first side plate 31 and the inertia member 36 therethrough to each other. According to this configuration, the first side plate 31 and the inertia member 36 can be fastened to each other by the one or more bolts 114 inserted thereto from the first side in the axial direction.

### LIST OF REFERENCE NUMERALS

3: Torque limiter, 31: First side plate, 311: First annular portion, 312: First cylindrical portion, 32: Second side plate, 321: Second annular portion, 322: Second cylindrical portion, 33: Friction plate, 36: Inertia member, 361: Screw hole, 37: First fastening member, 38: Second fastening member, 4: Damper unit, 41: First rotary member, 412: Outer peripheral surface, 412a: Contact portion, 412b: Non-contact portion, 42: Second rotary member, 43: Elastic member, 100: Power transmission device, 110: Drive plate.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “plurality,” as used herein, can encompass the configuration in which each element of a plurality of elements has a different shape or structure from each other in addition to the configuration in which the plurality of elements have the same shapes or structures as each other.

The terms “a” (or “an”), “one or more” and “at least one” can be used interchangeably herein. The phrase “at least one of” as used in this disclosure means “one or more” of a desired choice.

Terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Modifications and variations of the present invention will be apparent to one of ordinary skill in the art in light of this disclosure. It is therefore to be understood that within the scope of the appended claims, the invention may be practiced otherwise than as specifically described herein.

1. A power transmission device comprising:
a torque limiter including a first side plate, a second side plate, and a friction plate, the second side plate being disposed on a first side of the first side plate in an axial direction, the second side plate being smaller in plate thickness than the first side plate, the second side plate including an annular portion and a cylindrical portion, the annular portion extending in a circumferential direction, the cylindrical portion extending from an outer peripheral end of the annular portion to the first side in the axial direction, the friction plate being disposed axially between the first and second side plates, the friction plate being disposed to be rotatable relative to the first and second side plates; and
a damper unit including a first rotary member, a second rotary member, and an elastic member, the first rotary member being configured to be rotated unitarily with the friction plate, the first rotary member including an outer peripheral surface in contact with an inner peripheral surface of the cylindrical portion, the second rotary member being disposed to be rotatable relative to the first rotary member, the elastic member elastically coupling the first and second rotary members therethrough to each other.

2. The power transmission device according to claim 1, wherein the outer peripheral surface of the first rotary member includes
a contact portion extending in a circular-arc shape as seen in the axial direction, the contact portion being in contact with the inner peripheral surface of the cylindrical portion, and
a non-contact portion extending straight as seen in the axial direction, the non-contact portion being not in contact with the inner peripheral surface of the cylindrical portion.

3. The power transmission device according to claim 1, wherein an outer peripheral edge of the first rotary member is disposed radially outside an outer peripheral edge of the friction plate.

4. The power transmission device according to claim 1, wherein
the torque limiter includes a fastening member, the fastening member fastening the first and second side plates therethrough to each other, and
the cylindrical portion is disposed radially outside the fastening member.

5. The power transmission device according to claim 1, wherein the torque limiter includes an inertia member, the inertia member configured to be rotated unitarily with the first side plate.

6. The power transmission device according to claim 5, wherein
the torque limiter includes a fastening member fastening the first side plate and the inertia member therethrough to each other, and
the cylindrical portion is disposed radially outside the fastening member.

7. The power transmission device according to claim 5, wherein the inertia member includes a screw hole extending in the axial direction.

8. The power transmission device according to claim 5, wherein
the inertia member is made in a shape of an annulus extending in the circumferential direction, and
the inertia member is larger in plate thickness than the first side plate.

9. The power transmission device according to claim 5, wherein the inertia member is a nut with a thickness larger than the plate thickness of the first side plate.

10. The power transmission device according to claim 5, further comprising:
a drive plate disposed on a second side of the first side plate in the axial direction, wherein
the first side plate is configured to be rotated unitarily with the drive plate, and
the inertia member is disposed axially between the drive plate and the first side plate.

11. The power transmission device according to claim 1, wherein the first side plate includes an annular portion and a cylindrical portion, the annular portion of the first side plate extending in the circumferential direction, the cylindrical portion of the first side plate extending from an outer peripheral end of the annular portion of the first side plate to a second side in the axial direction.

12. The power transmission device according to claim 2, wherein an outer peripheral edge of the first rotary member is disposed radially outside an outer peripheral edge of the friction plate.

13. The power transmission device according to claim 3, wherein
the torque limiter includes a fastening member, the fastening member fastening the first and second side plates therethrough to each other, and
the cylindrical portion is disposed radially outside the fastening member.

14. The power transmission device according to claim 2, wherein the torque limiter includes an inertia member, the inertia member configured to be rotated unitarily with the first side plate.

15. The power transmission device according to claim 6, wherein the inertia member includes a screw hole extending in the axial direction.

16. The power transmission device according to claim 6, wherein
the inertia member is made in a shape of an annulus extending in the circumferential direction, and
the inertia member is larger in plate thickness than the first side plate.

17. The power transmission device according to claim 6, wherein the inertia member is a nut with a thickness larger than the plate thickness of the first side plate.

18. The power transmission device according to claim 6, further comprising:
a drive plate disposed on a second side of the first side plate in the axial direction, wherein
the first side plate is configured to be rotated unitarily with the drive plate, and
the inertia member is disposed axially between the drive plate and the first side plate.

19. The power transmission device according to claim 2, wherein the first side plate includes an annular portion and a cylindrical portion, the annular portion of the first side plate extending in the circumferential direction, the cylindrical portion of the first side plate extending from an outer peripheral end of the annular portion of the first side plate to a second side in the axial direction.

20. The power transmission device according to claim 3, wherein the first side plate includes an annular portion and a cylindrical portion, the annular portion of the first side plate extending in the circumferential direction, the cylindrical portion of the first side plate extending from an outer peripheral end of the annular portion of the first side plate to a second side in the axial direction.
